(19) United States
(12) Patent Application Publication
(10) Pub. No.: US 2004/0069639 A1
(43) Pub. Date: Apr. 15, 2004

(54) Resin chip

(76) Inventor: Koichi Ono, Saitama (JP)

Correspondence Address: BACHMAN & LAPOINTE, P.C., 900 CHAPEL STREET, SUITE 1201, NEW HAVEN, CT, 06510, US

(21) Appl. No.: 10/684,174

(22) Filed: Oct. 9, 2003

(30) Foreign Application Priority Data
Oct. 15, 2002 (JP) P2002-301140

(51) Int. Cl. G01N 27/27

(52) U.S. Cl. 204/603; 204/612

(57) ABSTRACT

A resin chip 1 has a plate 2 and a lid member 3 fixed to the surface 4 of the plate 2. The plate 2 is formed by the injection molding. The surface 4 of the plate 2 has first and second grooves 5 and 6 having a fine cross section. A pair of sample receiving holes 8 are formed in both end portions of each of the first and second grooves 5 and 6. The plate 2 has a recessed portion 11 on the side of the reverse surface 7 so as to correspond to a part of the first groove 5 which is a region (measuring region) to be irradiated with light. Thus, the thickness t1 of the bottom portion of the first groove 5 in the measuring region is thinner than other portions so as to easily transmit ultraviolet rays. On the other hand, portions of the plate 2 having no recessed portion 11 are so thicker as to be difficult to transmit ultraviolet rays. Thus, it is difficult to detect excessive light with which a sample in the first groove 5 has not been irradiated, so that the sensitivity of measurement is improved.

### BACKGROUND OF THE INVENTION

1. Field of the Invention

The present invention generally relates to a resin chip. More specifically, the invention relates to a resin chip capable of being used as a microchip (e.g., a capillary electrophoresis chip) in a technical field called integrated chemistry.

2. Description of the Prior Art

In recent years, there is known a technique called integrated chemistry for forming a fine groove having a width and depth of about tens to two hundreds micrometers in a micro chip of a glass or plastic, to use the fine groove as a liquid passage, reaction vessel or separation/purification detecting vessel, to integrate a complicated chemical system into the micro chip. According to such integrated chemistry, a micro chip (Lab-on-chip) having a fine groove used in various tests is called μ-TAS (Total Analytical System) if the use of the micro chip is limited to analytical chemistry, and the micro chip is called micro reactor if the use of the micro chip is limited to a reaction. When various tests, such as analyses, are carried out, integrated chemistry has advantages that the time to transport diffuse molecules is short due to small space and that the heat capacity of a liquid phase is very small. Therefore, integrated chemistry is noticed in the technical field wherein a micro space is intended to be utilized for carrying out analysis and chemical synthesis. The term “test” means to carry out any one or combination of operations and means, such as analysis, measurement, synthesis, decomposition, mixing, molecular transportation, solvent extraction, solid phase extraction, phase separation, phase combination, molecule acquisition, culture, heating and cooling.

In such integrated chemistry, a capillary electrophoresis chip used in a test in the field of, e.g., biochemistry, has a fine groove or circular recessed portion having a width and depth of about 10 to 200 micrometers in the chip of a glass or plastic, to use the fine groove or recessed portion as a liquid passage or reaction vessel to separate and identify a very small amount of vital materials, such as nucleic acids and proteins, and other low molecular materials. Therefore, materials to be handled have a very small volume of nanoliters to picoliters, so that it is required to precisely form the fine groove.

There has been developed and known a technique for forming a fine groove in the surface of a glass substrate by etching (see, e.g., Japanese Patent Laid-Open No. 2000-121547). In this conventional technique, a part of a fine groove formed in the glass substrate is used as a measuring chamber. The part of the fine groove used as the measuring chamber is irradiated with ultraviolet rays to measure the quantity of ultraviolet absorbed into a sample injected into the fine groove. In this conventional technique, in order to enhance the sensitivity of measurement, a shading film (a shading film prepared by oxidizing an etching protective film) is formed on the surface of the glass substrate except for the fine groove, to allow the permeation of ultraviolet only in the part of the fine groove to prevent stray light (excessive light with which the sample has not been irradiated) from entering a detector.

However, the above described conventional technique requires many steps, which take a lot of time, in order to form the fine groove in the glass substrate. That is, in the above described conventional technique, the fine groove is formed in the surface of the glass substrate by a method comprising the steps of: (a) spin-coating a photo resist on an etching protective film which is formed on the surface of a glass substrate by means of a sputtering deposition system; (b) exposing and developing the photo resist using a photo mask; (c) patterning the photo resist and the etching protective film by the dry etching using high-frequency plasma; and (d) etching the glass substrate with a predetermined solution by using the patterned etching protective film and photo resist as masks. Therefore, it takes a lot of time to form the fine groove, so that the glass substrate having the fine groove thus formed, and a micro chip (a detector cell) using the glass substrate are very expensive.

### SUMMARY OF THE INVENTION

It is therefore an object of the present invention to eliminate the aforementioned problems and to provide an inexpensive resin chip which is capable of being substituted for a conventional micro chip and which has a high sensitivity of measurement.

In order to accomplish the aforementioned and other objects, according to one aspect of the present invention, a resin chip comprises: a first member having an elongated groove on one side thereof, the groove having a fine cross section, the groove having a region which is to be irradiated with light; and a second member fixed to the one side of the first member, wherein the first member has a recessed portion on the other side thereof, which is opposite to the one side, in at least the region, the groove having a bottom portion having such a thickness that light easily pass through the bottom portion.

In this resin chip, the recessed portion may have a side wall serving as a condensing wall for reflecting irradiating light toward a bottom face of the recessed portion. The first member may be formed of the same resin material as that of the second member. The first member may be formed by injection molding.

According to another aspect of the present invention, a resin chip comprises: a first resin member having a groove on one side thereof, the groove having a fine cross section and a predetermined length, at least a part of the groove being arranged in a light irradiation region which is to be irradiated with light; and a second resin member, fixed to the one side of the first resin member, for covering the groove, wherein the first resin member has a recessed portion on the other side thereof, the recessed portion being associated with the groove for allowing light to easily pass through the first and second resin members in the light radiation region.

In this resin chip, the recessed portion may be arranged in the light irradiation region. The groove may have a groove width of about ten to two hundreds micrometers, and a groove depth of about ten to two hundreds micrometers. The first resin member may have a sample receiving hole which communicates with the groove. The recessed portion may have a side wall serving as a condensing wall for reflecting light toward the groove in the light irradiation region. The first resin member may be formed of the same resin material as that of the second member. The first resin member may be formed by injection molding.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a plan view of a plate for forming a preferred embodiment of a resin chip according to the present invention;

FIG. 2 is a sectional view of the plate taken along line II-II of FIG. 1;

FIG. 3 is an enlarged sectional view of a part of the plate taken along line III-III of FIG. 1;

FIG. 4 is an enlarged sectional view of another example of a recessed portion of the plate of FIG. 1;

FIG. 5 is a plan view of a preferred embodiment of a resin chip according to the present invention;

FIG. 6 is a sectional view of the resin chip taken along line VI-VI of FIG. 5; and

FIG. 7 is a sectional view for explaining an example of a use for the preferred embodiment of a resin chip according to the present invention, which shows a state that the resin chip of FIG. 6 is turned over.

### DESCRIPTION OF THE PREFERRED EMBODIMENTS

Referring now to the accompanying drawings, the preferred embodiments of a resin chip according to the present invention will be described below in detail. In the following preferred embodiments, a resin chip used as a capillary electrophoresis chip will be described as an example.

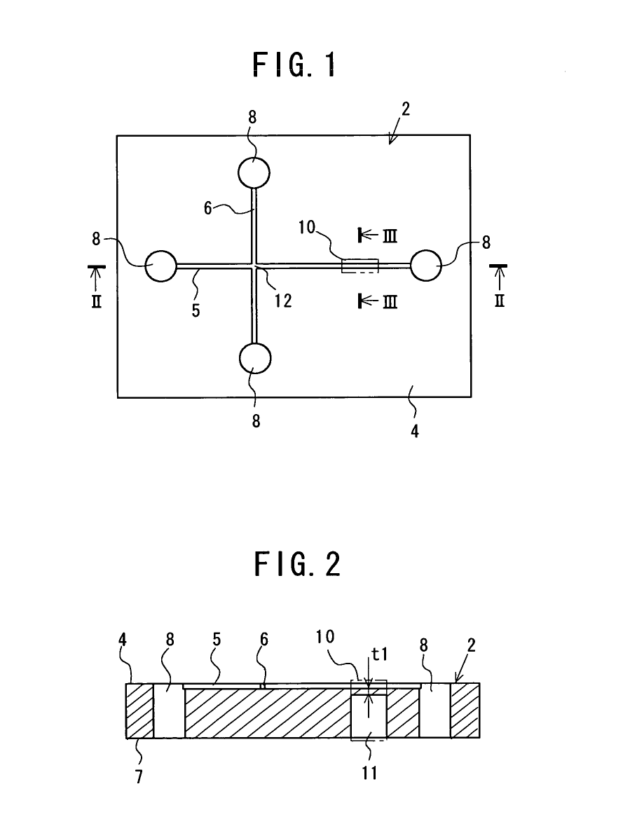

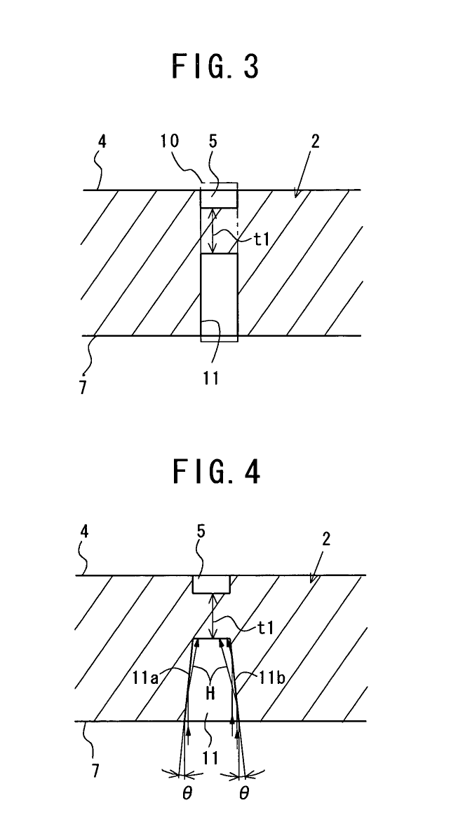

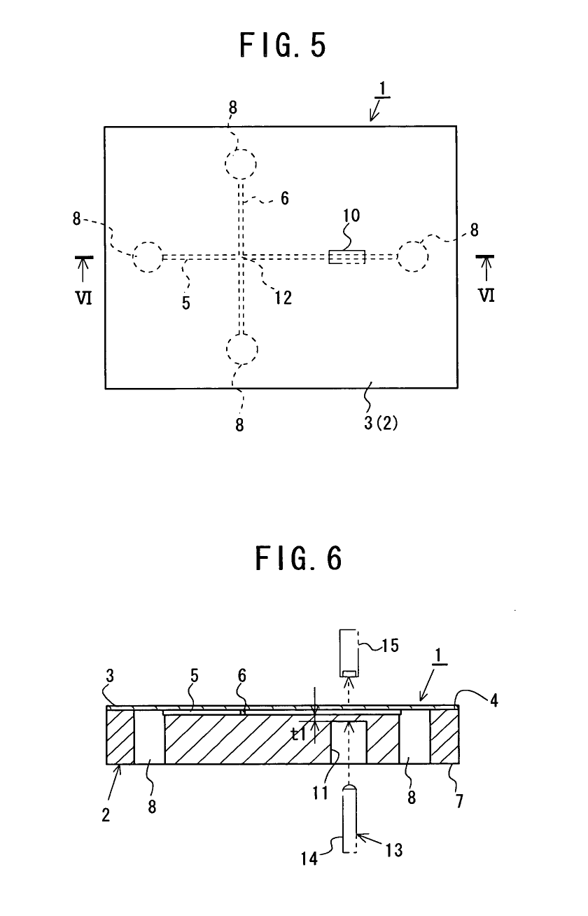

FIGS. 1 through 3 shows a plate (a first member) 2 of a preferred embodiment of a resin chip 1 according to the present invention. FIG. 1 is a plan view of the plate 2. FIG. 2 is a sectional view of the plate 2 taken along line II-II of FIG. 1, and FIG. 3 is an enlarged sectional view of a part of the plate 2 taken along line III-III of FIG. 1. FIG. 5 is a plan view of the resin chip 1 using the plate 2 shown in FIGS. 1 through 3, and FIG. 6 is a sectional view thereof.

The plate 2 and a lid member (a second member 3) shown in these figures are formed of a resin material, such as acrylate, polycarbonate or polyolefin, which has an excellent ultraviolet ray (UV) permeability, and are preferably formed of the same material. If the plate 2 and the lid member 3 are formed of the same material, the surface charge of the plate 2 can be the same as that of the lid member 3, so that the electroosmosis flow to a sample during electrophoresis can be uniform to cause the flow of the sample to be constant.

As shown in FIGS. 1 through 3, the plate 2 is formed by the injection molding, and has a substantially flat plate shape. The surface (first face) 4 of the plate 2 is formed with a first elongated straight fine groove 5 which extends in lateral directions in FIG. 1, and a second fine groove 6 which extends in directions perpendicular to the first groove 5. The first groove 5 and second groove 6 of the plate 2 have a substantially rectangular cross section (for example, a rectangular cross section having a groove width of 100 μm and a groove depth of 50 μm), and an overall length of a few centimeters. A pair of sample receiving holes 8 and 8 passing through the plate 2 from the surface 4 to reverse surface (second face) 7 of the plate 2 are formed in both end portions of each of the first groove 5 and second groove 6 so as to communicate with the first groove 5 and second groove 6, respectively (see FIG. 1). The size of the sample receiving holes 8 is sufficient to receive therein an electrophoresis solution and a sample, and the sample receiving holes 8 have a diameter of about hundreds micrometers to twenty millimeters.

As shown in FIGS. 1 through 3, the plate 2 has an inspecting light irradiating region (a measuring region) 10, which is irradiated with inspecting light (ultraviolet rays), in the middle of the first groove 5. On the side of the reverse surface 7 in the measuring region 10, a substantially rectangular recessed portion 11 is formed so as to correspond to the first groove 5. The recessed portion 11 substantially has the same groove width as that of the first groove 5. The recessed portion 11 has such a groove depth that ultraviolet rays easily pass through the bottom portion of the first groove 5 having a thickness t1 (e.g., 200 μm). In this preferred embodiment, the plate 2 has a thickness of 1 mm in view of working conditions.

As shown in FIGS. 5 and 6, the lid member 3 is a resin film of the same material as that of the plate 2, and has the same flat plane shape as that of the plate 2. The lid member 3 has a thickness of 100 μm. The lid member 3 is fixed to the plate 2 by the thermo compression bonding so as to cover the surface 4 of the plate 2. That is, if the lid member 3 is aligned with and fixed to the surface 4 of the plate 2, the first and second grooves 5, 6 and sample receiving holes 8 of the plate 2 on the side of the surface 4 thereof are covered with the lid member 3, so that the resin chip 1 in this preferred embodiment is completed. The lid member 3 should not be limited to the film, but the lid member 3 may be a plate member. The lid member 3 is preferably as thin as possible, if the quantity of transmitted ultraviolet is intended to increase.

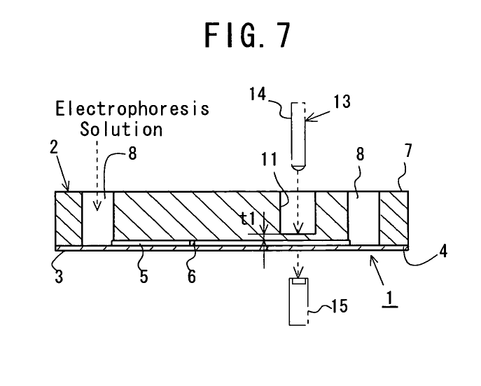

Referring to FIGS. 5 through 7, an example of a use for the resin chip 1 thus formed will be briefly described. As shown in FIG. 7, the resin chip 1 in this preferred embodiment is turned over to inject an electrophoresis solution into the second groove (sample passage) and first groove (analytical passage) 5 via any one of the sample receiving holes 8. Then, a sample is injected into the second groove 6 via any one of the sample receiving holes 8 which are arranged in the end portions of the second groove 6. In this state, a predetermined voltage is applied between both ends of the second groove 6 for a predetermined period of time, so that the sample is moved to a cross portion 12 between the second groove 6 and the first groove 5. Then, a predetermined voltage is applied between both ends of the first groove 5 for carrying out electrophoresis, so that a very small amount of sample existing in the cross portion 12 is moved (separated). Then, the sample in the first groove 5 is irradiated with ultraviolet rays from a light emitting device 14 of a measuring system 13 arranged in the measuring region 10 of the first groove 5, and the quantity of ultraviolet transmitted through the resin chip 1 is measured by a light receiving device 15 of the measuring system 13.

According to this preferred embodiment with this construction, the plate 2 having the fine grooves (the first and second grooves 5 and 6) and sample receiving holes 8 is formed by the injection molding. Therefore, the resin chip 1 capable of being used as a capillary electrophoresis chip can be produced in large quantities in a short time, so that it is possible to provide inexpensive resin chips 1. The resin chip 1 in this preferred embodiment can be more inexpensively scraped (burned up) than conventional micro chips being a glass chip.

According to this preferred embodiment, the recessed portion 11 is formed in the measuring region 10 of the plate 2, which is irradiated with ultraviolet rays, so as to correspond to the first groove 5 of the plate 2, and the thickness t1 of the bottom portion of the first groove 5 in the measuring region 10 is small, so that irradiating rays (ultraviolet rays) to the first groove 5 in the measuring region 10 are easily transmitted through the plate 2. On the other hand, portions of the plate 2, in which the recessed portion 11 is not formed, are so thick as to absorb a large quantity of ultraviolet, so that it is difficult for ultraviolet rays to be transmitted through the portions. Therefore, according to this preferred embodiment, it is difficult for stray light (excessive light with which the sample has not been irradiated) to enter the light receiving device 15 of the measuring system 13, so that the sensitivity of measurement is improved.

FIG. 4 shows a modified example of the recessed portion 11 of the plate 2 in the above described preferred embodiment. As shown in this figure, the recessed portion 11 may have a substantially trapezoidal cross section, and side walls 11a and 11b facing each other may be inclined by an angle θ so as to approach each other as a distance from the opening portion increases toward the bottom portion. The recessed portion 11 having such a shape causes the total reflection of light H, which is emitted from the light emitting device 14, on the inclined side walls 11a and 11b, so that the sample can be irradiated with the reflected light H. Therefore, the side walls 11a and 11b serve as condensing walls, so that it is expected to further improve the sensitivity of measurement.

While sample irradiating light (illuminating light) has been ultraviolet in the above described preferred embodiment, the present invention should not be limited thereto, but visible light may be used as the illuminating light. In this case, the plate 2 of the resin chip 1 is preferably formed of a material which is prepared by mixing an appropriate amount of an additive (e.g., a pigment) in a resin material, such as polyolefin, to reasonably deteriorate permeability with respect to visible light. In the case of the plate 2 of the resin chip 1 formed of such a resin material containing additive, the thickness t1 of the bottom portion of the first groove in the measuring region is so set as to transmit visible light or easily transmit visible light, and the thickness of portions having no recessed portion 11 is so set as not to transmit visible light or as to be difficult to transmit visible light.

In this modified example, the lid member 3 may be formed of a resin material which contains an appropriate amount of the same additive as that of the plate 2 to deteriorate transparency, or may be formed of a transparent resin material containing no additives. The lid member 3 formed of a transparent resin may be a film or a plate member.

If the resin chip 1 is thus constructed, even if illuminating light is visible light, it is difficult for stray light to enter the light receiving device 15 of the measuring system 13, so that the sensitivity of measurement with respect to the sample can be improved.

In this modified example, the reason why the appropriate amount of additive is mixed in order to deteriorate permeability with respect to visible light is that the thickness of the resin chip 1 is decreased. However, the present invention should not be limited thereto. For example, the surface of the portion of the plate 2 having no recessed portion 11 may have fine irregularities to irregularly reflect light on the irregularities to deteriorate permeability of light with respect to the surface of the portion of the plate 2 having no recessed portion 11. Thus, it is also possible to provide a resin chip 1 having a good sensitivity of measurement.

The sectional shape of the first and second grooves 5 and 6 (fine grooves) according to the present invention should not be limited to the rectangular shape in the above described preferred embodiment, but it may be another shape, such as a semicircular shape, U shape or substantially triangular shape.

The plane shape of the fine grooves 5 and 5 according to the present invention should not be limited to the cross shape in the above described preferred embodiment, but it may have another complicated shape, such as a linear shape (I shape), Y shape or curved shape.

While the groove width and groove depth of the fine grooves (the first and second grooves 5 and 6) have been constant in the above described preferred embodiment, the present invention should not be limited thereto, but the groove width and the groove depth may be suitably varied.

While the resin chip 1 serving as a capillary electrophoresis chip used for carrying out a test in the field of biochemistry has been described as an example for convenience of explanation in the above described preferred embodiments, the resin chip 1 according to the present invention should not be limited thereto, but it may be widely applied to chemical tests in various fields, such as the fields of synthetic chemistry and analytical chemistry, in addition to the field of biochemistry.

The numerical values in the above described preferred embodiment are examples for understanding, and the present invention should not be limited thereto, but optimum values may be set in accordance with working conditions and so forth.

In the above described preferred embodiment, the lid member 3 may be formed of a different material from that of the plate 2, and a film of the same material as that of the plate 2 may be formed on a portion of the lid member 3 contacting a sample.

In the above described preferred embodiment, the recessed portion 11 may be formed in the whole region of the first groove 5 so as to correspond to the first groove 5, and the thickness t1 of the whole bottom portion of the first groove 5 may be small.

While the plate 2 has been formed by the injection molding in the above described preferred embodiment, the present invention should not be limited thereto, but the plate 2 may be formed by another resin molding method (for example, compression molding, vacuum molding or extrusion molding).

As described above, according to the present invention, the recessed portion is formed in the region of the plate, which is irradiated with measuring light, so as to correspond to the groove having the fine cross section, and the bottom portion of the groove in the region irradiated with the measuring light is thin, so that light with which a sample is irradiated is easy to transmit the plate. On the other hand, the portions of the plate having no recessed portion are so thick as to be difficult to transmit light. Therefore, in the resin chip according to the present invention, it is difficult for stray light (excessive light with which the sample has not been irradiated) to enter the light receiving device of the measuring system, so that the sensitivity of measurement is improved.

In addition, according to the present invention, the plate having the fine grooves and sample receiving holes is formed by the injection molding. Therefore, resin chips capable of being used as capillary electrophoresis chips or the like can be produced in large quantities in a short time, so that it is possible to provide inexpensive resin chips having a constant quality.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

What is claimed is:

1. A resin chip comprising:
a first member having a groove on one side thereof, said groove having a fine cross section and a predetermined length, said groove having a region which is to be irradiated with light; and
a second member fixed to said one side of said first member,
wherein said first member has a recessed portion on the other side thereof, which is opposite to said one side, in at least said region, said groove having a bottom portion having such a thickness that light easily pass through the bottom portion.

2. A resin chip as set forth in claim 1, wherein said recessed portion has a side wall serving as a condensing wall for reflecting irradiating light toward a bottom face of said recessed portion.

3. A resin chip as set forth in claim 1, wherein said first member is formed of the same resin material as that of said second member.

4. A resin chip as set forth in claim 1, wherein said first member is formed by injection molding.

5. A resin chip comprising:
a first resin member having an elongated groove on one side thereof, said groove having a fine cross section, at least a part of said groove being arranged in a light irradiation region which is to be irradiated with light; and
a second resin member, fixed to said one side of said first resin member, for covering said groove,
wherein said first resin member has a recessed portion on the other side thereof, said recessed portion being associated with said groove for allowing light to easily pass through said first and second resin members in said light radiation region.

6. A resin chip as set forth in claim 5, wherein said recessed portion is arranged in said light irradiation region.

7. A resin chip as set forth in claim 5, wherein said groove has a groove width of about ten to two hundreds micrometers, and a groove depth of about ten to two hundreds micrometers.

8. A resin chip as set forth in claim 5, wherein said first resin member has a sample receiving hole which communicates with said groove.

9. A resin chip as set forth in claim 5, wherein said recessed portion has a side wall serving as a condensing wall for reflecting light toward said groove in said light irradiation region.

10. A resin chip as set forth in claim 5, wherein said first resin member is formed of the same resin material as that of said second member.

11. A resin chip as set forth in claim 5, wherein said first resin member is formed by injection molding.
